(19) United States
(12) Patent Application Publication
(10) Pub. No.: US 2012/0191784 A1
(43) Pub. Date: Jul. 26, 2012

(54) DESKTOP SHARING SYSTEM AND METHOD

(75) Inventors: CHUNG-I LEE, Tu-Cheng (TW); CHIEN-FA YEH, Tu-Cheng (TW); TSUNG-HSIN YEN, Tu-Cheng (TW)

(73) Assignee: HON HAI PRECISION INDUSTRY CO., LTD., Tu-Cheng (TW)

(21) Appl. No.: 13/308,553

(22) Filed: Dec. 1, 2011

(30) Foreign Application Priority Data
Jan. 20, 2011 (TW) 100102021

(51) Int. Cl. G06F 15/16; G06F 3/048

(52) U.S. Cl. 709/205; 715/733

(57) ABSTRACT

In a desktop sharing method implemented by a server, the server communicates with a sharing provider through a first network and one or more sharing receivers through a second network. A desktop sharing request to share the desktop of the sharing provider with a sharing receiver is received from the sharing provider. The desktop sharing request is sent to the sharing receiver, and a response message is received from the sharing receiver. A bandwidth of the second network between the server and the sharing receiver is detected if the sharing receiver accepts the desktop sharing request, and a video of the desktop of the sharing provider composed of base layer video streams and additional layer video streams are received in real-time. The base layer video streams and the additional layer video streams of the video are selectively transmitted to the sharing receiver according to the bandwidth.

### BACKGROUND

1. Technical Field

Embodiments of the present disclosure relate generally to data sharing technologies, and particularly to a desktop sharing system and method of data sharing in network systems.

2. Description of Related Art

Computing devices, such as computer and mobile devices, can share their desktops with each other through networks, using desktop sharing technologies. Some video coding technologies may provide high definition (HD) desktop videos to be shared among the computing devices. However, if the bandwidth of the network of a computing device is not wide enough, the computing device may not share the HD desktop videos in real-time. Therefore, a more efficient desktop sharing system and method is desired.

### BRIEF DESCRIPTION OF THE DRAWINGS

FIG. 1 is a schematic diagram illustrating one embodiment of in a server including a desktop sharing system.

FIG. 2 is a block diagram of one embodiment of functional modules of the desktop sharing system of FIG. 1.

FIG. 3 is a flowchart of one embodiment of a desktop sharing method that is executed using the desktop sharing system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

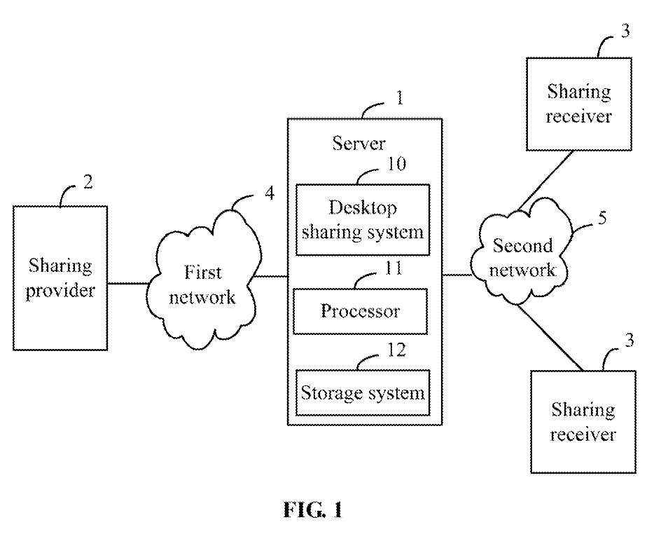

FIG. 1 is a schematic diagram illustrating one embodiment of a server 1 including a desktop sharing system 10. The server 1 communicates with a sharing provider 2 through a first network 4, and one or more sharing receivers 3 through a second network 5. In one embodiment, both the first network 4 and the second network 5 may be, for example, an Ethernet, or a local area network (LAN). Both of the sharing provider 2 and the sharing receiver 3 may be, for example, a computer, a mobile device, or other computing devices. The server 1 further includes a processor 11, and a storage system 12. FIG. 1 is only one example of the server 1 and can include more or fewer components than those shown in the embodiment, or a different configuration of the various components.

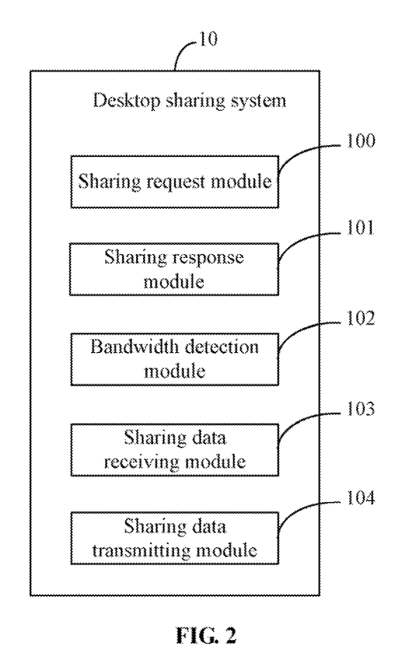

FIG. 2 is a block diagram of one embodiment of functional modules of the desktop sharing system 10 of FIG. 1. In one embodiment, the desktop sharing system 10 may include a plurality of software programs in the form of one or more computerized instructions stored in the storage system 12 and executed by the processor 11, to perform operations of the server 1. In the embodiment, the desktop sharing system 10 includes a sharing request module 100, a sharing response module 101, a bandwidth detection module 102, a sharing data receiving module 103, and a sharing data transmitting module 104. In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The sharing request module 100 receives a request from the sharing provider 2 to share a desktop of the sharing provider 2 with a sharing receiver 3. The request is known as a desktop sharing request. The desktop of the sharing provider 2 refers to a graphic user interface (GUI) that is displayed on a screen of the sharing provider 2. The desktop may include many computer contents, such as texts, images, and icons.

The sharing response module 101 sends the desktop sharing request to the sharing receiver 3. After the desktop sharing request is sent to the sharing receiver 3, the sharing response module 101 receives a response message of the desktop sharing request from the sharing receiver 3, and determines whether the sharing receiver 3 accepts the desktop sharing request according to the response message. In addition, the sharing response module 101 may return the response message to the sharing provider 2 to indicate whether the sharing receiver 3 agrees to share the desktop of the sharing provider 2.

The bandwidth detection module 102 detects a bandwidth of the second network 5 between the server 1 and the sharing receiver 3 if the sharing receiver 3 accepts the desktop sharing request. In the embodiment, the bandwidth describes the amount of data that can be transferred between the server 1 and the sharing receiver 3 through the second network within a prescribed period of time, such as one second.

The sharing data receiving module 103 receives a video of the desktop of the sharing provider 2. In the embodiment, the sharing provider 2, using a scalable video coding method encodes the video of the desktop of the sharing provider 2. The video includes a plurality of real-time images of the desktop that are encoded to be multi-layered video streams using the scalable video coding method. The multi-layered video streams are composed of base layer video streams and additional layer video streams. The base layer video streams include basic video images of the desktop that have a lower frame rate, a lower resolution, and a lower image quality. The additional layer video streams may enhance the frame rate, resolution, and image quality of the base layer video streams. In other embodiments, if the bandwidth of the first network 4 between the sharing provider 2 and the server 1 is not enough to transmit both the base layer video streams and the additional layer video streams to the server 1 in real-time, the sharing provider 2 may only transmit the base layer video streams to the server 1.

The sharing data transmitting module 104 selectively transmits the base layer video streams, or both the base layer video streams and the additional layer video streams of the video to the sharing receiver 3 according to the bandwidth of the second network 5 between the server 1 and the sharing receiver 3. In one embodiment, if the bandwidth is greater than or equal to a predetermined value, such as 512 Kbit/s, or 1 Mbit/s, the sharing data transmitting module 104 may transmit both the base layer video streams and the additional layer video streams of the video to the sharing receiver 3. If the bandwidth is less than the predetermined value, the sharing data transmitting module 104 may only transmit the base layer video streams of the video to the sharing receiver 3, to share the video of the desktop of the sharing provider 2 in real-time.

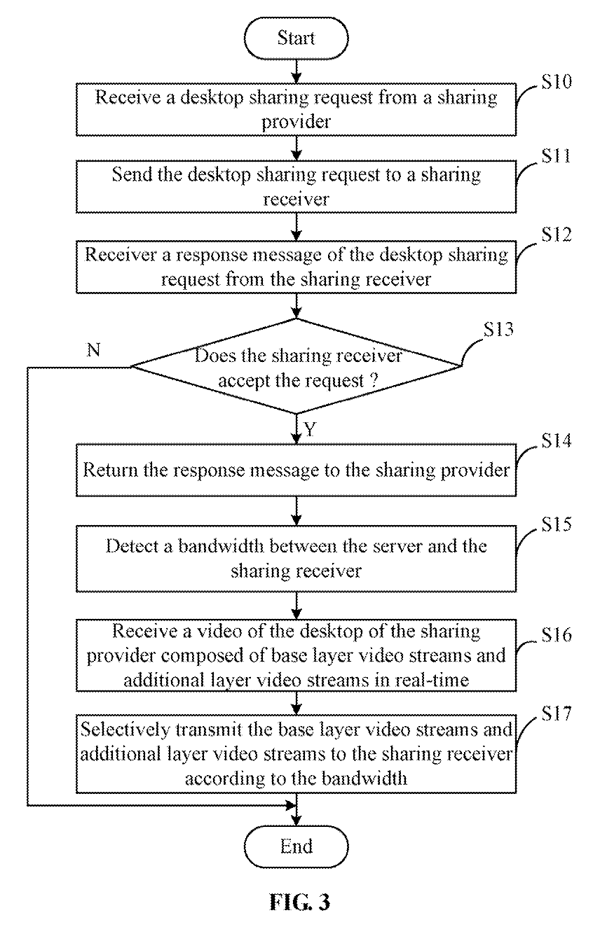

FIG. 3 is a flowchart of one embodiment of a desktop sharing method that is executed using the desktop sharing system of FIG. 1. Depending on the embodiment, additional blocks may be added, others removed, and the ordering of the blocks may be changed.

In block S10, the sharing request module 100 receives a request from the sharing provider 2 to share the desktop of the sharing provider 2 with a sharing receiver 3. In the embodiment, the request refers to the desktop sharing request.

In block S11, the sharing response module 101 sends the desktop sharing request to the sharing receiver 3. When the desktop sharing request is sent to the sharing receiver 3, the sharing receiver 3 may return a response message to the server 1.

In block S12, the sharing response module 101 receives the response message of the desktop sharing request from the sharing receiver 3.

In block S13, the sharing response module 101 determines whether the sharing receiver 3 accepts the desktop sharing request according to the response message. If the sharing receiver 3 accepts the desktop sharing request, block S14 is implemented. If the sharing receiver 3 does not accept the desktop sharing request, ends the procedure.

In block S14, the sharing response module 101 returns the response message to the sharing provider 2 to indicate the sharing provider 2 that the sharing receiver 3 agrees to share the desktop of the sharing provider 2.

In block S15, the bandwidth detection module 102 detects a bandwidth of the second network 5 between the server 1 and the sharing receiver 3. In the embodiment, the bandwidth describes the amount of data transferred between the server 1 and the sharing receiver 3 through the second network 5 within a prescribed period of time, such as one second.

In block S16, the sharing data receiving module 103 receives a video of the desktop of the sharing provider 2 in real-time. In the embodiment, the sharing provider 2, using a scalable video coding method, encodes the video of the desktop of the sharing provider 2. The video includes a plurality of real-time images of the desktop that are encoded to be multi-layered video streams using the scalable video coding method. The multi-layered video streams are composed of base layer video streams and additional layer video streams. The base layer video streams include basic video images of the desktop that have a lower frame rate, a lower resolution, and a lower image quality. The additional layer video streams may enhance the frame rate, resolution, and image quality of the base layer video streams.

In block S17, the sharing data transmitting module 104 selectively transmits the base layer video streams, or both the base layer video streams and the additional layer video streams of the video to the sharing receiver 3 according to the bandwidth of the second network 5 between the server 1 and the sharing receiver 3. In one embodiment, if the bandwidth is greater than or equal to a predetermined value, such as 512 Kbit/s, or 1 Mbit/s, the sharing data transmitting module 104 may transmit both the base layer video streams and the additional layer video streams of the video to the sharing receiver 3. If the bandwidth is less than the predetermined value, the sharing data transmitting module 104 may only transmit the base layer video streams of the video to the sharing receiver 3, to share the video of the desktop of the sharing provider 2 in real-time

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized desktop sharing method implemented by a server, the server in communication with a sharing provider through a first network and one or more sharing receivers through a second network, the method comprising:
receiving a desktop sharing request from the sharing provider to share a desktop of the sharing provider with a sharing receiver;
sending the desktop sharing request to the sharing receiver, and receiving a response message of the desktop sharing request from the sharing receiver;
determining whether the sharing receiver accepts the desktop sharing request according to the response message;
detecting a bandwidth of the second network between the server and the sharing receiver if the sharing receiver accepts the desktop sharing request;
receiving a video of the desktop of the sharing provider that is composed of base layer video streams and additional layer video streams in real-time;
transmitting the base layer video streams, or both the base layer video streams and the additional layer video streams of the video to the sharing receiver according to the bandwidth of the second network between the server and the sharing receiver.

2. The method according to claim 1, wherein the transmitting step transmits the base layer video streams to the sharing receiver if the bandwidth is greater than or equal to a predetermined value, or transmits both the base layer video streams and the additional layer video streams to the sharing receiver if the bandwidth is less than the predetermined value.

3. The method according to claim 1, wherein the base layer video streams comprise basic video images that have a lower frame rate, a lower resolution, and a lower image quality, and the additional layer video streams are operable to enhance the frame rate, the resolution, and the image quality of the base layer video streams.

4. The method according to claim 1, wherein the sending step further comprises:
returning the response message to the sharing provider to indicate whether the sharing receiver agrees to share the desktop of the sharing provider.

5. A server in communication with a sharing provider through a first network, and one or more sharing receiver through a second network, the server comprising:
a storage system;
at least one processor;
one or more programs stored in the storage system and being executable by the at least one processor, the one or more programs comprising:
a sharing request module operable to receive a desktop sharing request from the sharing provider to share a desktop of the sharing provider with a sharing receiver;
a sharing response module operable to send the desktop sharing request to the sharing receiver, receive a response message of the desktop sharing request from the sharing receiver, and determine whether the sharing receiver accepts the desktop sharing request according to the response message;
a bandwidth detection module operable to detect a bandwidth of the second network between the server and the sharing receiver if the sharing receiver accepts the desktop sharing request;
a sharing data receiving module operable to receive a video of the desktop of the sharing provider that is composed of base layer video streams and additional layer video streams in real-time;
a sharing data transmitting module operable to transmit the base layer video streams, or both the base layer video streams and the additional layer video streams of the video to the sharing receiver according to the bandwidth of the second network between the server and the sharing receiver.

6. The server according to claim 5, wherein the sharing data transmitting module transmits the base layer video streams to the sharing receiver if the bandwidth is greater than or equal to a predetermined value, or transmits both the base layer video streams and the additional layer video streams to the sharing receiver if the bandwidth is less than the predetermined value.

7. The server according to claim 5, wherein the base layer video streams comprise basic video images that have a lower frame rate, a lower resolution, and a lower image quality, and the additional layer video streams are operable to enhance the frame rate, resolution, and image quality of the base layer video streams.

8. The server according to claim 5, wherein the sharing response module further operable to return the response message to the sharing provider to indicate whether the sharing receiver agrees to share the desktop of the sharing provider.

9. A non-transitory storage medium storing a set of instructions, the set of instructions capable of being executed by a processor of a server, cause the server to perform a desktop sharing method, the server in communication with a sharing provider through a first network, and one or more sharing receivers through a second network, the method comprising:
receiving a desktop sharing request from the sharing provider to share a desktop of the sharing provider with a sharing receiver;
sending the desktop sharing request to the sharing receiver, and receiving a response message of the desktop sharing request from the sharing receiver;
determining whether the sharing receiver accepts the desktop sharing request according to the response message;
detecting a bandwidth of the second network between the server and the sharing receiver if the sharing receiver accepts the desktop sharing request;
receiving a video of the desktop of the sharing provider that is composed of base layer video streams and additional layer video streams in real-time;
transmitting the base layer video streams, or both the base layer video streams and the additional layer video streams of the video to the sharing receiver according to the bandwidth of the second network between the server and the sharing receiver.

10. The non-transitory storage medium according to claim 9, wherein the transmitting step transmits the base layer video streams to the sharing receiver if the bandwidth is greater than or equal to a predetermined value, or transmits both the base layer video streams and the additional layer video streams to the sharing receiver if the bandwidth is less than the predetermined value.

11. The non-transitory storage medium according to claim 9, wherein the base layer video streams comprise basic video images that have a lower frame rate, a lower resolution, and a lower image quality, and the additional layer video streams are operable to enhance the frame rate, resolution, and image quality of the base layer video streams.

12. The non-transitory storage medium according to claim 9, wherein the sending step further comprises:
returning the response message to the sharing provider to indicate whether the sharing receiver agrees to share the desktop of the sharing provider.
